(19) United States
(12) Patent Application Publication
(10) Pub. No.: US 2011/0142678 A1
(43) Pub. Date: Jun. 16, 2011

(54) EROSION PROTECTION COATING FOR ROTOR BLADE OF WIND TURBINE

(75) Inventors: Pedro Luis Benito Santiago, Mostoles (ES); Eugenio Yegro Segovia, Serranillos del Valle (ES); Po Wen Cheng, Delft (NL)

(73) Assignee: GENERAL ELECTRIC COMPANY, Schenectady, NY (US)

(21) Appl. No.: 12/952,552

(22) Filed: Nov. 23, 2010

(51) Int. Cl. F03B 3/12

(52) U.S. Cl. 416/241 R

(57) ABSTRACT

A rotor blade assembly for a wind turbine is disclosed. The rotor blade assembly includes a rotor blade having surfaces defining a pressure side, a suction side, a leading edge, and a trailing edge extending between a tip and a root. The rotor blade assembly further includes an erosion protection coating configured on a surface of the rotor blade. The erosion protection coating includes a ceramic layer, the ceramic layer having a thickness of less than approximately 10 millimeters. The ceramic layer is configured to reduce erosion of the rotor blade.

### FIELD OF THE INVENTION

The present disclosure relates in general to wind turbine rotor blades, and more particularly to coatings applied to the rotor blades to protect the rotor blades from erosion.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

During the operation of a wind turbine, the rotor blades may be subjected to a wide variety of environmental conditions. In many cases, such as when the wind turbines are located in coastal or desert areas, the rotor blades may be subjected to environmental conditions that include abrasive materials, such as sand particles and/or rain droplets. The interaction of these abrasive materials with the rotor blades may cause portions of the rotor blades to erode. In particular, the leading edges of rotor blades may be highly susceptible to erosion. Erosion of the various portions of the rotor blades limits the maximum rotational speed of the rotor blades, thus limiting the power output of the wind turbine.

One prior art solution for reducing similar erosion issues involves the use of a thick ceramic cap mounted to a blade. This prior art cap has a thickness greater than 10 millimeters, and is preferably in the range from 10 millimeters to 1,000 millimeters. However, the use of such a cap has a variety of disadvantages when applied to wind turbine rotor blades. For example, as the size of the wind turbines and rotor blades increases, the size of the cap must also increase. Such a large, thick cap would be extremely heavy, increasing the stress on and limiting the speed of the rotor blades. Further, these prior art caps would be particularly susceptible to cracking due to vibrations during the continuous operation of the wind turbine.

Thus, an improved erosion protection coating for a rotor blade would be desired. For example, an erosion protection coating that is relatively thin and light would be advantageous. Additionally, an erosion protection coating that includes components for reducing the transmission of rotor blade stress and strain to the erosion protection coating would be desired. Further, an erosion protection coating that includes components for the prevention of fouling during operation of the rotor blade would be desired.

### BRIEF DESCRIPTION OF THE INVENTION

Aspects and advantages of the invention will be set forth in part in the following description, or may be obvious from the description, or may be learned through practice of the invention.

In one embodiment, a rotor blade assembly for a wind turbine is disclosed. The rotor blade assembly includes a rotor blade having surfaces defining a pressure side, a suction side, a leading edge, and a trailing edge extending between a tip and a root. The rotor blade assembly further includes an erosion protection coating configured on a surface of the rotor blade. The erosion protection coating includes a ceramic layer, the ceramic layer having a thickness of less than approximately 10 millimeters. The ceramic layer is configured to reduce erosion of the rotor blade.

In another embodiment, a rotor blade assembly for a wind turbine is disclosed. The rotor blade assembly includes a rotor blade having surfaces defining a pressure side, a suction side, a leading edge, and a trailing edge extending between a tip and a root. The rotor blade assembly further includes an erosion protection coating configured on the leading edge of the rotor blade and extending in the generally span-wise direction along substantially the entire outer half of the rotor blade. The erosion protection coating includes a ceramic layer. The ceramic layer is configured to reduce erosion of the rotor blade.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of one embodiment of a wind turbine of the present disclosure;

FIG. 2 is a perspective view of one embodiment of a rotor blade assembly of the present disclosure;

FIG. 3 is a cross-sectional view of one embodiment of a rotor blade assembly of the present disclosure;

FIG. 4 is a cross-sectional view, along the lines 4--4 of FIG. 3, of one embodiment of an erosion protection coating of the present disclosure;

FIG. 5 is a cross-sectional view of another embodiment of a rotor blade assembly of the present disclosure;

FIG. 6 is a cross-sectional view, along the lines 6--6 of FIG. 5, of another embodiment of an erosion protection coating of the present disclosure;

FIG. 7 is a cross-sectional view of another embodiment of a rotor blade assembly of the present disclosure; and,

FIG. 8 is a cross-sectional view, along the lines 8--8 of FIG. 7, of another embodiment of an erosion protection coating of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

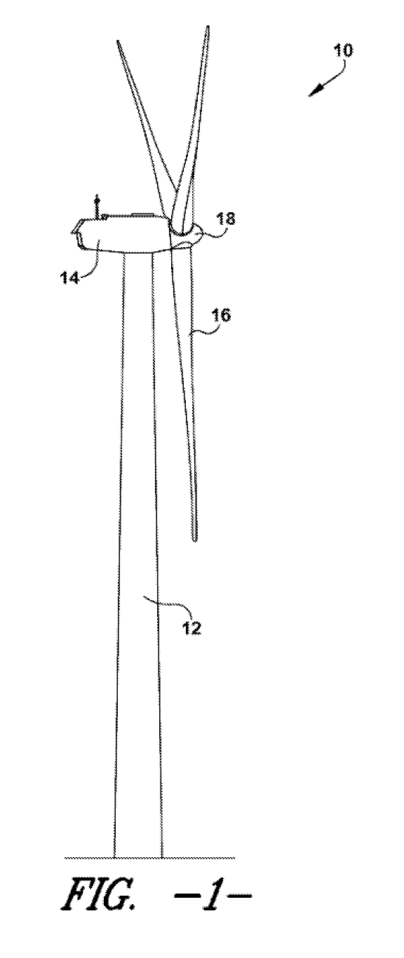

FIG. 1 illustrates a wind turbine 10 of conventional construction. The wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

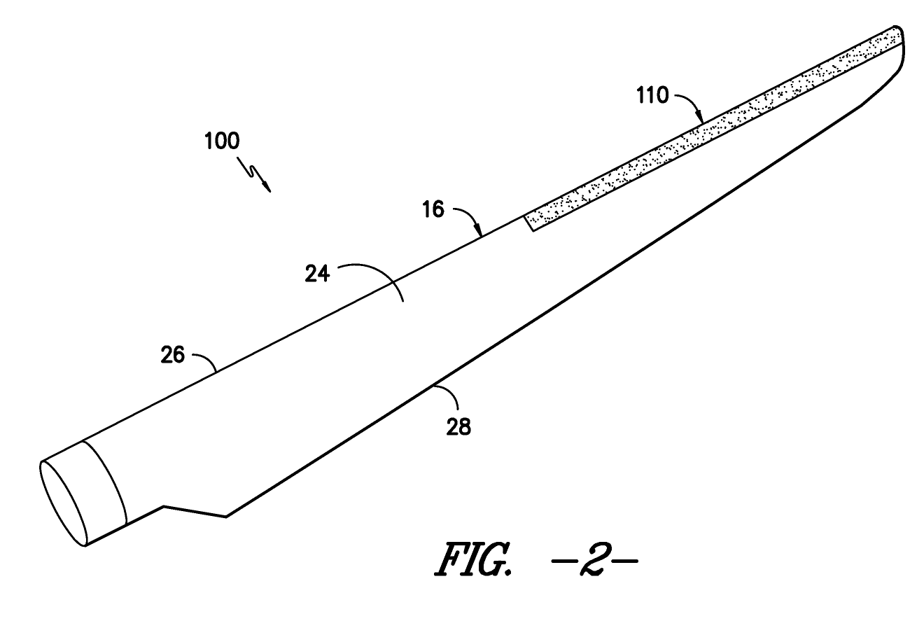

Referring to FIG. 2, a rotor blade 16 according to the present disclosure may include surfaces defining a pressure side 22 (see FIGS. 3, 5, and 7) and a suction side 24 extending between a leading edge 26 and a trailing edge 28, and may extend from a blade tip 32 to a blade root 34.

In some embodiments, the rotor blade 16 may include a plurality of individual blade segments aligned in an end-to-end order from the blade tip 32 to the blade root 34. Each of the individual blade segments may be uniquely configured so that the plurality of blade segments define a complete rotor blade 16 having a designed aerodynamic profile, length, and other desired characteristics. For example, each of the blade segments may have an aerodynamic profile that corresponds to the aerodynamic profile of adjacent blade segments. Thus, the aerodynamic profiles of the blade segments may form a continuous aerodynamic profile of the rotor blade 16. Alternatively, the rotor blade 16 may be formed as a singular, unitary blade having the designed aerodynamic profile, length, and other desired characteristics.

The rotor blade 16 may, in exemplary embodiments, be curved. Curving of the rotor blade 16 may entail bending the rotor blade 16 in a generally flapwise direction and/or in a generally edgewise direction. The flapwise direction may generally be construed as the direction (or the opposite direction) in which the aerodynamic lift acts on the rotor blade 16. The edgewise direction is generally perpendicular to the flapwise direction. Flapwise curvature of the rotor blade 16 is also known as pre-bend, while edgewise curvature is also known as sweep. Thus, a curved rotor blade 16 may be pre-bent and/or swept. Curving may enable the rotor blade 16 to better withstand flapwise and edgewise loads during operation of the wind turbine 10, and may further provide clearance for the rotor blade 16 from the tower 12 during operation of the wind turbine 10.

As illustrated in FIGS. 2 through 8, the present disclosure may further be directed to a rotor blade assembly 100. The rotor blade assembly 100 includes the rotor blade 16, as discussed above. Further, the rotor blade assembly 100 includes an erosion protection coating 110. As discussed below, the erosion protection coating 110 may include various layers formed of various materials for reducing erosion of the rotor blade 16 and otherwise protecting the rotor blade 16 and erosion protection coating 110.

The erosion protection coating 110 may be configured on a surface of the rotor blade 16. In exemplary embodiments, the erosion protection coating 110 may be configured on the leading edge 26 of the rotor blade 16. Further, in embodiments wherein the erosion protection coating 110 is configured on the leading edge 26, the coating 110 may further extend at least partially onto the pressure side 22 and/or the suction side 24, as desired to provide suitable erosion protection. Additionally or alternatively, the erosion protection coating 110 may be configured on any suitable surface or surfaces of the rotor blade 16, such as the pressure side 22, the suction side 24, the trailing edge 28, the tip 32, and/or the root 34.

In some exemplary embodiments, the erosion protection coating 110 may be configured on only a portion of the rotor blade 16 along the length of the rotor blade in the generally span-wise direction. For example, the erosion protection coating 110 may be configured on approximately the outer half of the length of the rotor blade 16 or, in exemplary embodiments, approximately the outer third of the length of the rotor blade 16 (in other words, the approximate half or third of the length of the rotor blade 16 that includes the tip 32). Thus, the erosion protection coating may extend in the generally span-wise direction along substantially the entire outer half of the rotor blade 16, or along substantially the entire outer third of the rotor blade 16.

However, it should be understood that the present disclosure is not limited to the erosion protection coating 110 being configured on or extending through only a certain portion of the length of the rotor blade 16. Rather, any configuration of the erosion protection coating 110 on any portion of the length of the rotor blade 16 is within the scope and spirit of the present disclosure.

As shown in FIGS. 3 through 8, the erosion protection coating 110 includes a ceramic layer 112. The ceramic layer 112 may be configured to reduce erosion of the rotor blade 16. Thus, the ceramic layer 112 may protect the surface of the rotor blade 16 that the erosion protection coating 110 is configured on when the rotor blade 16 is subjected to conditions that cause erosion, such as abrasive environmental conditions including, for example, sand particles and/or rain droplets. For example, in exemplary embodiments, the ceramic layer 112 may comprise tungsten carbide, silicon carbide, silicon nitride, or aluminum oxide. Alternatively, the ceramic layer 112 may include any suitable ceramic material that has properties sufficient to reduce erosion of the rotor blade 16, as discussed below.

The ceramic layer 112 according to the present disclosure is a relatively thin ceramic layer 112. Various forms of the ceramic layer 112 and various application methods, as discussed below, may be utilized to ensure that the ceramic layer 112 is relatively thin. Thus, the ceramic layer 112 of the present disclosure has a thickness 114 of less than approximately 10 millimeters. Further, the ceramic layer 112 may have a thickness 114 of equal to or less than approximately 5 millimeters, equal to or less than approximately 2 millimeters, or in exemplary embodiments equal to or less than approximately 1 millimeter. The relatively thin ceramic layer 112 of the present disclosure ensures that the erosion protection coating 110 does not add an undesirable amount of weight to the rotor blade 16, such that the stress on the rotor blade 16 is not increased and the speed of the rotor blade 16 is not decreased.

Further, in some embodiments, the thickness 114 of the ceramic layer 112, and/or of the erosion protection coating 110 in general, may taper throughout a portion of the ceramic layer 112 and erosion protection coating 110. For example, in embodiments wherein the erosion protection coating 110 is configured on the leading edge 26, a portion of the ceramic layer 112 and/or the erosion protection coating 110 extending towards or configured on the pressure side 22 and/or the suction side 24 may taper. The taper may be such that the outer surface of the rotor blade assembly 100 is generally continuous between the erosion protection coating 110 and the remaining surface of the rotor blade 16. In alternative embodiments, however, the thickness 114 of the ceramic layer 112, and/or of the erosion protection coating 110 in general, may remain generally constant, or may increase, or change as desired.

The ceramic layer 112 according to the present disclosure is a relatively hard ceramic layer 112. In some embodiments, for example, the ceramic layer 112 may have a hardness value of up to approximately 8 according to the Mohrs scale. In other embodiments, the ceramic layer 112 may have a hardness value in the range between approximately 10 gigapascals and approximately 40 gigapascals according to the Vickers scale.

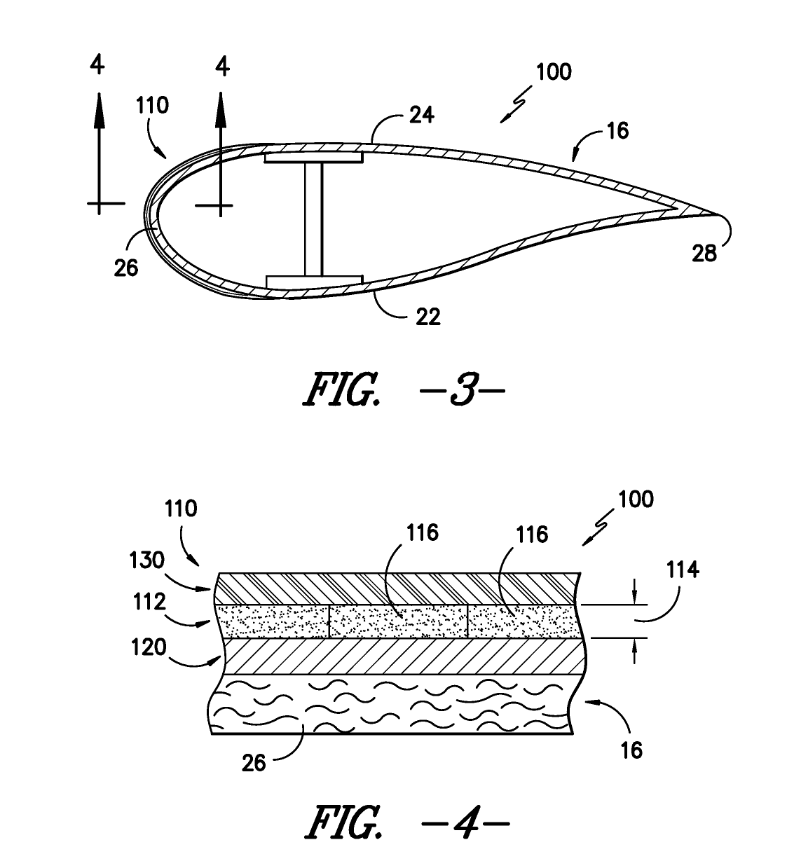

In some embodiments, as shown in FIG. 4, the ceramic layer 112 may comprise a plurality of ceramic tiles 116. The ceramic tiles 116 may be mounted to the rotor blade 16 and disposed adjacent each other to form the ceramic layer 112. The ceramic tiles 116 may be formed using any suitable ceramic processing apparatus or method. In some embodiments, the ceramic tiles 116 may be mounted directly to a surface of the rotor blade 16, such as through a suitable adhesive. In other embodiments, another layer or layers of the erosion protection coating 110, such as an elastic layer and/or a lightning protection web as discussed below, may be mounted between the ceramic tiles 116 and the surface of the rotor blade 16. The ceramic tiles 116 may be mounted to the additional layer or layers through a suitable adhesive, or the additional layer or layers may be coated on the surfaces of the ceramic tiles 116 that are configured to interact with the surface of the rotor blade 16.

In other embodiments, as shown in FIGS. 6 and 8, the ceramic layer 112 may be a ceramic film 118 applied to the surface of the rotor blade 16. The ceramic film 118 may be applied to the surface of the rotor blade 16 through a variety of methods. For example, in some embodiments, the ceramic film 118 may be applied to the surface of the rotor blade 16 through a deposition method. Various suitable deposition methods include chemical vapor deposition, atomic layer deposition, laser deposition, and plasma deposition. In alternative embodiments, the ceramic film 118 may be applied to the surface of the rotor blade 16 as a ceramic powder or a ceramic liquid suspension. For example, the ceramic powder or ceramic liquid suspension may be sprayed onto the surface of the rotor blade 16, and the ceramic powder or ceramic liquid suspension may then be cured. In some embodiments, the curing process may be completed, for example, during the process of forming the rotor blade 16 in a mold. The ceramic powder or ceramic liquid suspension may be sprayed onto the substrate that will form the rotor blade 16 in the mold, and the substrate and ceramic powder or ceramic liquid suspension may be cured together to form the rotor blade 16 and ceramic film 118. If required, a different level of heat may be applied to the surfaces of the rotor blade 16 that include the ceramic powder or ceramic liquid suspension thereon than to the remaining surfaces of the rotor blade 16. In other embodiments, the curing process may be completed, for example, after the process of forming the rotor blade 16 in a mold. After curing the rotor blade 16, the ceramic powder or ceramic liquid suspension may be sprayed onto the surface of the rotor blade 16, and a required level of heat may be applied to the ceramic powder or ceramic liquid suspension to cure the ceramic powder or ceramic liquid suspension to form the ceramic film 118.

In some embodiments, as shown in FIG. 4, the erosion protection coating 110 further comprises an elastic layer 120. The elastic layer 120 may be disposed between the ceramic layer 112 and the surface of the rotor blade 16. In general, the elastic layer 120 is configured to reduce strain transmission between the rotor blade 16 and the ceramic layer 112. Thus, the elastic layer 120 may comprise a material suitable for at least partially absorbing the strain from the rotor blade 16 and preventing this strain from being transmitted to the ceramic layer 112. The elastic layer 120 may thus beneficially protect the ceramic layer 112 from damage due to the strain of the rotor blade 16.

In exemplary embodiments, for example, the elastic layer 120 may comprise polyurethane. Alternatively, the elastic layer 120 may comprise any relatively elastic material that is suitable for absorbing strain from the rotor blade 16 and reducing or preventing the strain being transmitted through the elastic layer 120 to the ceramic layer 112.

In some embodiments, as shown in FIGS. 4, 6, and 8, the erosion protection coating 110 further comprises a non-stick layer 130. The non-stick layer 120 may be disposed opposite the surface of the rotor blade 16 with respect to the ceramic layer 112. Thus, the non-stick layer 130 may be exterior to the ceramic layer 112. The non-stick layer 130 may be configured to reduce fouling of the rotor blade 16. Fouling of the rotor blade 16 occurs when materials such as, for example, particulate or bugs, adhere to a surface of the rotor blade 16. The non-stick layer 130 may prevent these materials from adhering to the surface of the rotor blade 16, thus keeping the surface of the rotor blade 16 relatively free from fouling. For example, in exemplary embodiments, the non-stick layer 130 may be a fluoropolymer. Suitable fluoropolymers may be, for example, polytetrafluoroethylene, perfluoroalkoxy, or fluorinated ethylene propylene. However, it should be understood that the non-stick layer 130 is not limited to the above disclosed fluoropolymers, and rather that any suitable fluoropolymer, or any suitable material that provides suitable non-stick qualities, is within the scope and spirit of the present disclosure.

In some embodiments, as shown in FIGS. 6 and 8, the erosion protection coating 110 further comprises a lightning protection web 140. The lightning protection web 140 may be configured to reduce lightning damage to the rotor blade 16. For example, the lightning protection web 140 may comprise a material suitable for conducting the electrical current from a lightning strike. In exemplary embodiments, the lightning protection web 140 may be formed from a metal or metal alloy. For example, the lightning protection web 140 may be formed from aluminum. Alternatively, however, the lightning protection web 140 may be formed from any suitable conductive material.

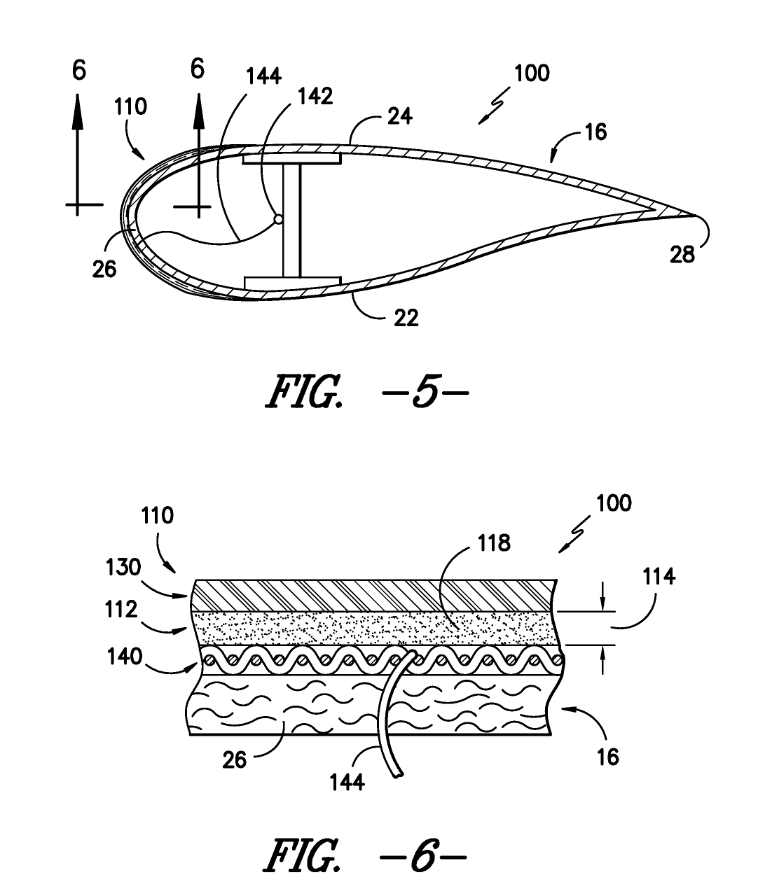

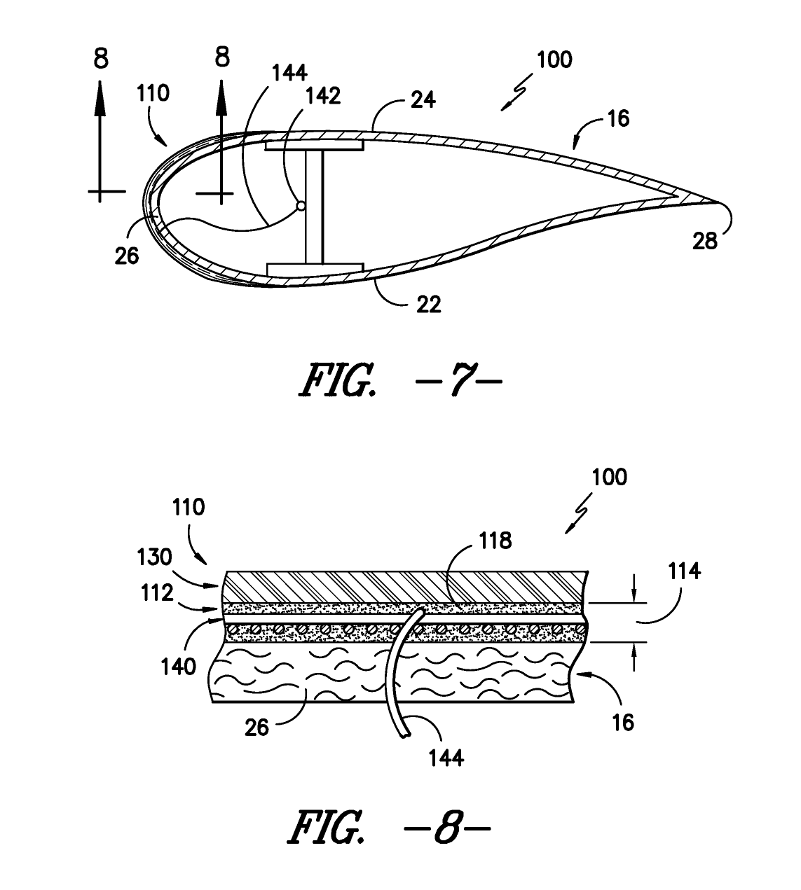

To reduce lightning damage to the rotor blade 16, the lightning protection web 140 may be operatively connected to a lightning protection device 142, as shown in FIGS. 5 and 7. In general, the lightning protection device 142 protects the rotor blade 16 and wind turbine 10 from lightning strikes. In exemplary embodiments, the lightning protection device 142 is a cable, such as a copper cable. The lightning protection device 142 may be disposed at least partially in the interior of the rotor blade 16. For example, the lightning protection device 142 may extend in the interior through at least a portion of the length of the rotor blade 16. Further, in some embodiments, the lightning protection device 142 may be connected at various locations along the length of the rotor blade 16 to one or more electrically conducting lightning receptors (not shown) disposed on one or more of the surfaces of the rotor blade 16. It should be understood that the lightning protection web 140 may replace or supplement the lightning receptors. The lightning protection device 142 may further be in conductive communication with a grounding system (not shown) in the wind turbine 10, such as in the tower 12 of the wind turbine 10.

Thus, when the lightning protection web 140 and lightning protection device 142 are operatively connected, the lightning protection device 142 may protect the lightning protection web 140 and rotor blade 16 from lightning strikes. The electrical current from lightning striking the erosion protection coating 110 may flow through the lightning protection web 140 to the lightning protection device 142. In some embodiments, a conduction cable 144 or a plurality of conduction cables 144, as shown in FIGS. 5 through 8, may be provided to operatively connect the lightning protection web 140 to the lightning protection device 142. The conduction cable 144 is connected at one end to the lightning protection web 140 and at the other end to the lightning protection device 142. Electrical current from lightning strikes to the erosion protection coating 110 may thus flow from the lightning protection web 140 through the conduction cable 144 to the lightning protection device 142, and through the lightning protection device 142 to the ground, thereby preventing damage to the rotor blade 16 and the wind turbine 10.

In some embodiments, as shown in FIG. 6, the lightning protection web 140 may be disposed between the ceramic layer 112 and the surface of the rotor blade 16. In these embodiments, the lightning protection web 140 may be a singular layer of material or a matrix of material, as desired. Further, if an additional layer such as the elastic layer 120 is included in the erosion protection coating 110, the lightning protection web 140 may be disposed between the ceramic layer 112 and the elastic layer 120, or between the elastic layer 120 and the surface of the rotor blade 16, or a lightning protection web 140 may be disposed between both.

In other embodiments, as shown in FIG. 8, another layer of the erosion protection coating 110, such as the ceramic layer 112, the elastic layer 120, or the non-stick layer 130, may comprise the lightning protection web 140. For example, FIG. 5 illustrates an exemplary embodiment wherein the ceramic layer 112 comprises the lightning protection web 140. In these embodiments, the lightning protection web 140 may generally be a matrix of material or a plurality of strands of the material that are embedded in the layer, such as in the ceramic layer 112.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade assembly for a wind turbine, comprising:
a rotor blade having surfaces defining a pressure side, a suction side, a leading edge, and a trailing edge extending between a tip and a root; and,
an erosion protection coating configured on a surface of the rotor blade, the erosion protection coating comprising a ceramic layer, the ceramic layer having a thickness of less than approximately 10 millimeters,
wherein the ceramic layer is configured to reduce erosion of the rotor blade.

2. The rotor blade assembly of claim 1, wherein the ceramic layer has a thickness of equal to or less than approximately 1 millimeter.

3. The rotor blade assembly of claim 1, wherein the ceramic layer comprises one of tungsten carbide, silicon carbide, silicon nitride, or aluminum oxide.

4. The rotor blade assembly of claim 1, wherein the ceramic layer comprises a plurality of ceramic tiles mounted to the rotor blade.

5. The rotor blade assembly of claim 1, wherein the ceramic layer is a ceramic film applied to the surface of the rotor blade.

6. The rotor blade assembly of claim 5, wherein the ceramic film is applied to the surface of the rotor blade through one of chemical deposition, atomic layer deposition, laser deposition, or plasma deposition.

7. The rotor blade assembly of claim 5, wherein the ceramic film is applied by spraying the surface of the rotor blade with one of a ceramic powder or a ceramic liquid suspension and curing the one of the ceramic powder or the ceramic liquid suspension.

8. The rotor blade assembly of claim 1, wherein the erosion protection coating further comprises an elastic layer disposed between the ceramic layer and the surface of the rotor blade, the elastic layer configured to reduce strain transmission between the rotor blade and the ceramic layer.

9. The rotor blade assembly of claim 8, wherein the elastic layer comprises polyurethane.

10. The rotor blade assembly of claim 1, wherein the erosion protection coating further comprises a non-stick layer disposed opposite the surface of the rotor blade with respect to the ceramic layer, the non-stick layer configured to reduce fouling of the rotor blade.

11. The rotor blade assembly of claim 10, wherein the non-stick layer comprises a fluoropolymer.

12. The rotor blade assembly of claim 1, wherein the erosion-protection coating further comprises a lightning protection web configured to reduce lightning damage to the rotor blade.

13. The rotor blade assembly of claim 12, wherein the ceramic layer comprises the lightning protection web.

14. The rotor blade assembly of claim 12, wherein the lightning protection web is disposed between the ceramic layer and the surface of the rotor blade.

15. A rotor blade assembly for a wind turbine, comprising:
a rotor blade having surfaces defining a pressure side, a suction side, a leading edge, and a trailing edge extending between a tip and a root; and,
an erosion protection coating configured on the leading edge of the rotor blade and extending in the generally span-wise direction along substantially the entire outer half of the rotor blade, the erosion protection coating comprising a ceramic layer,
wherein the ceramic layer is configured to reduce erosion of the rotor blade.

16. The rotor blade assembly of claim 15, wherein the erosion protection coating extends in the generally span-wise direction along substantially the entire outer third of the rotor blade.

17. A wind turbine, comprising:
a plurality of rotor blades, each of the plurality of rotor blades having surfaces defining a pressure side, a suction side, a leading edge, and a trailing edge extending between a tip and a root; and,
an erosion protection coating configured on a surface of at least one of the plurality of rotor blades, the erosion protection coating comprising a ceramic layer, the ceramic layer having a thickness of less than approximately 10 millimeters,
wherein the ceramic layer is configured to reduce erosion of the at least one rotor blade.

18. The wind turbine of claim 17, wherein the erosion protection coating further comprises an elastic layer disposed between the ceramic layer and the surface of the at least one rotor blade, the elastic layer configured to reduce strain transmission between the at least one rotor blade and the ceramic layer.

19. The wind turbine of claim 17, wherein the erosion protection coating further comprises a non-stick layer disposed opposite the surface of the rotor blade with respect to the ceramic layer, the non-stick layer configured to reduce fouling of the at least one rotor blade.

20. The wind turbine of claim 17, wherein the erosion-protection coating further comprises a lightning protection web configured to reduce lightning damage to the at least one rotor blade.
